(19) United States
(12) Patent Application Publication
(10) Pub. No.: US 2010/0149704 A1
(43) Pub. Date: Jun. 17, 2010

(54) ESD PROTECTION CIRCUIT

(76) Inventor: Jung-Eon Moon, Gyeonggi-do (KR)

Correspondence Address: IP & T Law Firm PLC, 7700 Little River Turnpike, Suite 207, Annandale, VA, 22003, US

(21) Appl. No.: 12/630,145

(22) Filed: Dec. 3, 2009

(30) Foreign Application Priority Data
Dec. 15, 2008 (KR) 10-2008-0127475

(51) Int. Cl. H02H 9/04

(52) U.S. Cl. 361/56

(57) ABSTRACT

An ESD protection circuit includes a detector coupled between a data power source line and a data ground voltage line to detect static electricity and to output a detection voltage at a detection node, a pre-driver coupled between a power source voltage line and a ground voltage line to output a driving signal at a control node, a data output driver coupled between a data input/output pad and the data ground voltage line to output data in response to the driving signal, and a controller coupled between the control node and the data ground voltage line to couple a terminal of the data output driver with the data ground voltage line based on the detection voltage when the static electricity is input.

### CROSS-REFERENCE TO RELATED APPLICATIONS

The present application claims priority of Korean Patent Application No. 10-2008-0127475, filed on Dec. 15, 2008, which is incorporated herein by reference in its entirety.

### BACKGROUND OF THE INVENTION

Exemplary embodiments of the present invention relate to an electrostatic (ESD) protection circuit for a semiconductor circuit, and more particularly, to a technology for protecting a data output driver and a data output resistor from operational failure occurring due to excessive static electricity.

When a semiconductor integrated circuit have a contact with an electrified human body or machine, static electricity electrifying the human body or machine may be discharged into the semiconductor integrated circuit through an external pin and input/output pad of the semiconductor integrated circuit, and an over-current having large energy may damage an internal circuit of the semiconductor integrated circuit.

Conversely, when a semiconductor circuit contacts an electrical device, static electricity electrifying the inside of the semiconductor circuit may be transmitted from the semiconductor circuit in the form of an over-current flowing through the machine, damaging an internal circuit of the electrical device.

Therefore, a semiconductor integrated circuit includes an ESD unit between an input/output pad and an internal circuit to protect the internal circuit from being damaged.

FIG. 1 illustrates a conventional ESD protection circuit mounted on a data input/output pad.

Referring to FIG. 1, the ESD protection circuit includes a first ESD unit 101, a second ESD unit 103, a data input/output pad 100, a data power source voltage line 102, a data ground voltage line 104, a power source voltage line 106, a ground voltage line 108, a data output driver and a data output resistor R1, which belong to a portion labeled with a reference numeral ‘110,’ a detector 112, a power clamp 114, and a pre-driver 116.

The data input/output pad 100 is used when data is input/output for a device such as a Dynamic Random Access Memory (DRAM). Generally, the data input/output pad 100 is referred to as a DQ pad, and power sources used for the data input/output pad 100 are the data power source voltage line 102 and the data ground voltage line 104.

The data input/output pad 100 functions as an interface between the DRAM and a system, and a signal between the DRAM and the system should be transferred based on a predetermined spec.

The pre-driver 116 and the data output (DOUT) driver, which are used when data is input/output, affect a signal waveform when data is output. In transferring a signal waveform to the system without any distortion, many different factors such as the area, length and resistance of the data output driver may affect the signal waveform, so that such values/features need to be designed properly.

The data output driver has a structure vulnerable to static electricity. When static electricity is generated in the data input/output pad 100, excessive static electricity current may be discharged mostly through the first and second ESD units 101 and 103. However, when some current flows to the data output driver, an operational failure may be caused.

Therefore, to protect the data output driver, which is vulnerable to static electricity, the data output resistor is disposed in an input portion of the data output driver. The data output resistor prevents/reduces static electricity current input to the data output driver.

However, conventional circuits for protecting against static electricity current that operates at a high speed tend to be designed to have a small resistance in the input portion of a data output driver to reduce distortion in a signal waveform when a signal is transferred to a system. As a result, the data output driver becomes more vulnerable to static electricity.

Hereinafter, referring to FIG. 1, a case where static electricity enters the data input/output pad 100 and an operational failure may occur in the data output driver 110 including an NMOS transistor N1 and the data output resistor R1 is described.

The NMOS transistor N1 has a gate coupled with a drain of the pre-driver 116, which is composed of a CMOS structure, and receives a signal from the pre-driver 116.

In a ground voltage line test mode where static electricity is intentionally provided into the data input/output pad 100 and discharged to ground voltage pads VSSQ and VSS, power source pads VDDQ and VDD are each in a floating state.

When the power source pads VDDQ and VDD are in a floating state, a power source (that is, a power supply) is not supplied to a PMOS of the pre-driver 116 and thus a gate of the NMOS transistor N1 is in the floating state.

When the gate of the NMOS transistor N1 has a high-level voltage higher than its threshold voltage before being placed in the floating state, a channel is formed in the NMOS transistor N1, and thus the static electricity current flows through the channel of the NMOS transistor N1.

The static electricity current induces an electric field between the bulk and the drain of the NMOS transistor N1 to turn on a parasitic NPN-type bipolar junction transistor.

When the parasitic NPN-type bipolar junction transistor is turned on before the first and second ESD units 101 and 103 are turned on, the static electricity input through the data input/output pad 100 flows to the NMOS transistor N1 and may cause the resistor R1 to melt and create a disconnect, or damage the NMOS transistor N1. As a result, operational failure may occur in the data output driver and the resistor.

### SUMMARY OF THE INVENTION

An exemplary embodiment of the present invention is directed to an electrostatic discharge (ESD) circuit to protect a semiconductor internal circuit from static electricity input to a data input/output pad.

Another embodiment of the present invention is directed to a circuit for preventing an operational failure from occurring by controlling the operation of a data output driver and preventing the data output driver from operating before an ESD unit operates when static electricity is input to a data input/output pad.

In accordance with an embodiment of the present invention, an ESD protection circuit includes: a detector coupled between a data power source line and a data ground voltage line to detect static electricity and to output a detection voltage on a detection node; a pre-driver coupled between a power source voltage line and a ground voltage line to output a driving signal on a control node; a data output driver coupled between a data input/output pad and the data ground voltage line to output data in response to the driving signal; and a controller coupled between the control node and the data ground voltage line to couple a terminal of the data output driver with the data ground voltage line based on the detection voltage when the static electricity is input.

The detector may include a capacitor coupled between the data power source line and the detection node; and a resistor coupled between the detection node and the data ground voltage line.

The ESD protection circuit may further include a power clamp coupled in parallel with the detector and to be turned on in response to the detection voltage. The power clamp may include an NMOS transistor having a drain coupled with the data power source line, a gate coupled with the detection node, and a source and a bulk coupled with the data ground voltage line.

The data output driver may include a resistor having one terminal coupled with the data input/output pad; and an NMOS transistor including a drain coupled with another terminal of the resistor, a gate coupled with the control node, and a source and a bulk coupled with the data ground voltage line.

The pre-driver may include a CMOS inverter between the power source voltage line and the ground voltage line and has an intervening node of a PMOS transistor and an NMOS transistor of the CMOS inverter coupled with the control node to output the driving signal.

The controller may include an NMOS transistor including a drain coupled with the control node, a gate coupled with the detection node, and a source and a bulk coupled with the data ground voltage line.

### BRIEF DESCRIPTION OF THE DRAWINGS

FIG. 1 illustrates a conventional electrostatic discharge (ESD) protection circuit mounted on a data input/output pad.

FIG. 2 illustrates an ESD protection circuit mounted on a data input/output pad in accordance with an embodiment of the present invention.

FIG. 3 is a graph showing a simulation result of a conventional data output driver.

FIG. 4 is a graph showing a simulation result of a data output driver in accordance with an embodiment of the present invention.

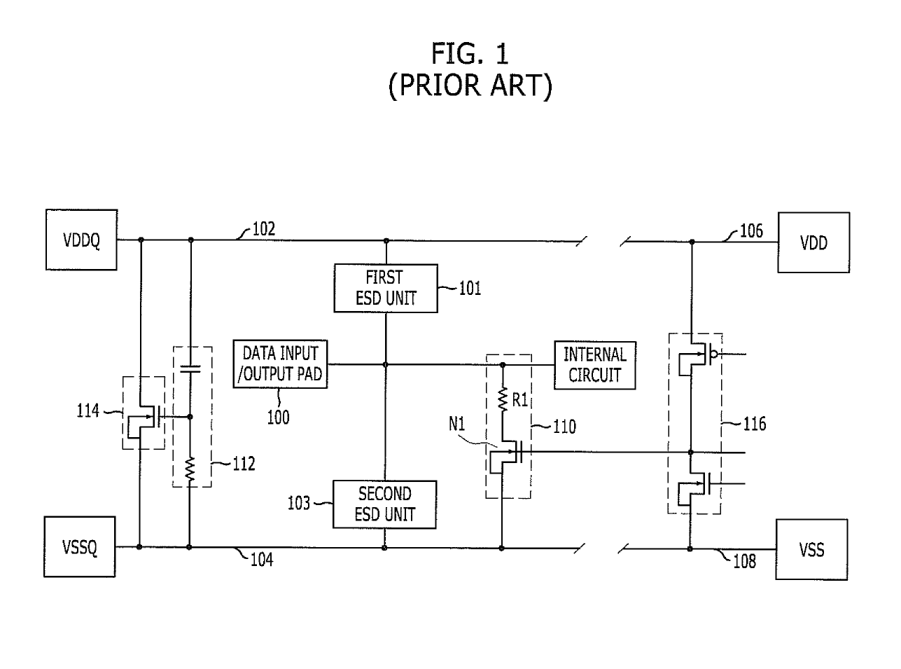

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments. When a first layer is referred to as being “on” a second layer or “on” a substrate, it not only refers to a case where the first layer is formed directly on, or over, the second layer or the substrate, but also a case where a third layer exists between the first layer and the second layer or the substrate.

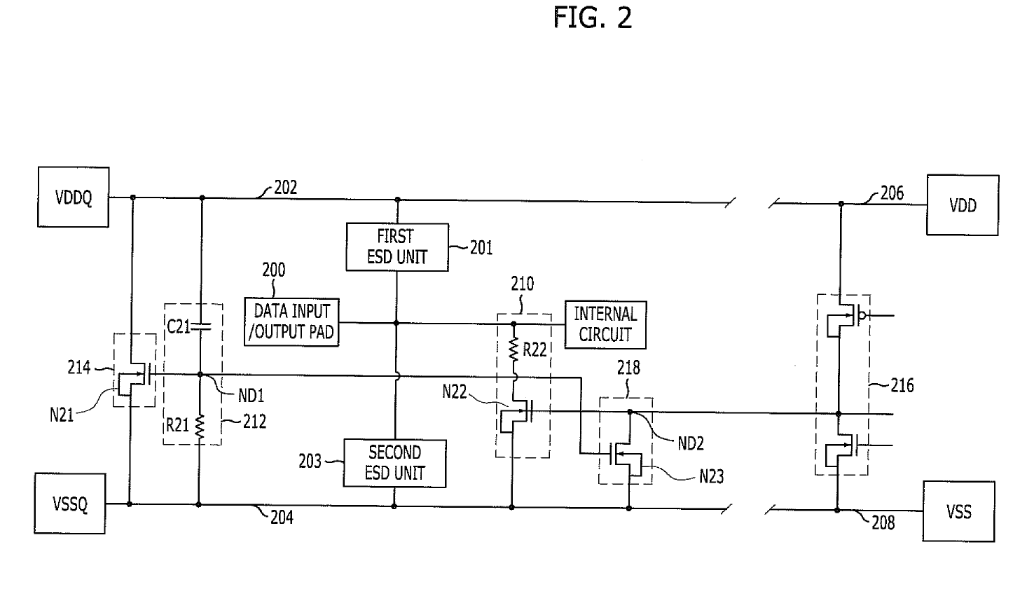

FIG. 2 illustrates an (ESD) protection circuit mounted on a data input/output pad in accordance with an embodiment of the present invention.

Referring to FIG. 2, the ESD protection circuit includes a first ESD unit 201, a second ESD unit 203, a data input/output pad 200, a data power source voltage line 202, a data ground voltage line 204, a power source voltage line 206, a ground voltage line 208, a data output driver 210, a detector 212, a power clamp 214, a pre-driver 216, and a controller 218.

The first ESD unit 201 and the second ESD unit 203 are disposed between the data input/output pad 200 and the data power source voltage line 202 or the data ground voltage line 204.

The data output driver 210 has a second NMOS transistor N22 having one terminal coupled with the data input/output pad 200 through a second resistor R22, and another terminal coupled with the data ground voltage line 204.

The detector 212 has a capacitor C21 and a first resistor R21 coupled in series with an intervening detection node ND1. The capacitor C21 has one terminal coupled with the data power source voltage line 202 and the first resistor R21 has one terminal coupled with the data ground voltage line 204.

The power clamp 214 includes a first NMOS transistor N21, which includes a drain coupled with the data power source voltage line 202, a source coupled with the data ground voltage line 204, and a gate coupled with the detection node ND1.

The pre-driver 216 is used to supplement a data input/output, and includes a CMOS inverter coupled between the power source voltage line 206 and the ground voltage line 208. The CMOS inverter is coupled with a drain of a third NMOS transistor N23 and a gate of the second NMOS transistor N22 through the control node ND2.

The controller 218 includes the third NMOS transistor N23, which includes the drain coupled with the control node ND2, a gate coupled with the detection node ND1, and a source coupled with the data ground voltage line 204.

Hereinafter, referring to FIG. 2, a specific operation of protecting against static electric current according to an exemplary embodiment of the present invention will be described.

When static electricity enters the data input/output pad 200, the static electricity may bypass the capacitor C21 and cause a voltage drop in the first resistor R21. As a result, a voltage is detected in the detection node ND1, and input to the gate of the third NMOS transistor N23. Since a high-level detection voltage is input to the gate of the third NMOS transistor N23, the third NMOS transistor N23 is turned on, and the voltage level of the control node ND2 transitions to the voltage level of the data ground voltage line 204.

As a result, since the gate of the second NMOS transistor N22 is coupled with the control node ND2, the gate of the second NMOS transistor N22 becomes coupled with the data ground voltage line 204.

As the gate of the second NMOS transistor N22 is coupled with the data ground voltage line 204, the second NMOS transistor N22 operates as a gate grounded NMOS transistor (GGNMOS).

When the second NMOS transistor N22 operates as the GGNMOS transistor, its operation voltage is increased. Thus, the operation voltage of the second NMOS transistor N22 becomes higher than the operation voltage of the first and second ESD units 201 and 203. Therefore, since the second NMOS transistor N22 does not operate before the first and second ESD units 201 and 203 operate, the second NMOS transistor N22 and the second resistor R22 are prevented from operational failure.

Meanwhile, when static electricity does not enter the data input/output pad 200 and the internal circuit performs a normal operation, there is no static electricity passing through the detector 212 and a voltage drop through the first resistor R21 does not occur. The voltage level of the detection node ND1 is the same as that of the data ground voltage line 204, that is, a low level.

Since the low-level voltage of the detection node ND1 is input to the gate of the third NMOS transistor N23, the third NMOS transistor N23 is turned off. Since the third NMOS transistor N23 is turned off, the control node ND2 is not connected with the data ground voltage line 204.

Therefore, while the gate of the second NMOS transistor N22 is driven by the pre-driver 216, the third NMOS transistor N23 does not influence the data output driver 210.

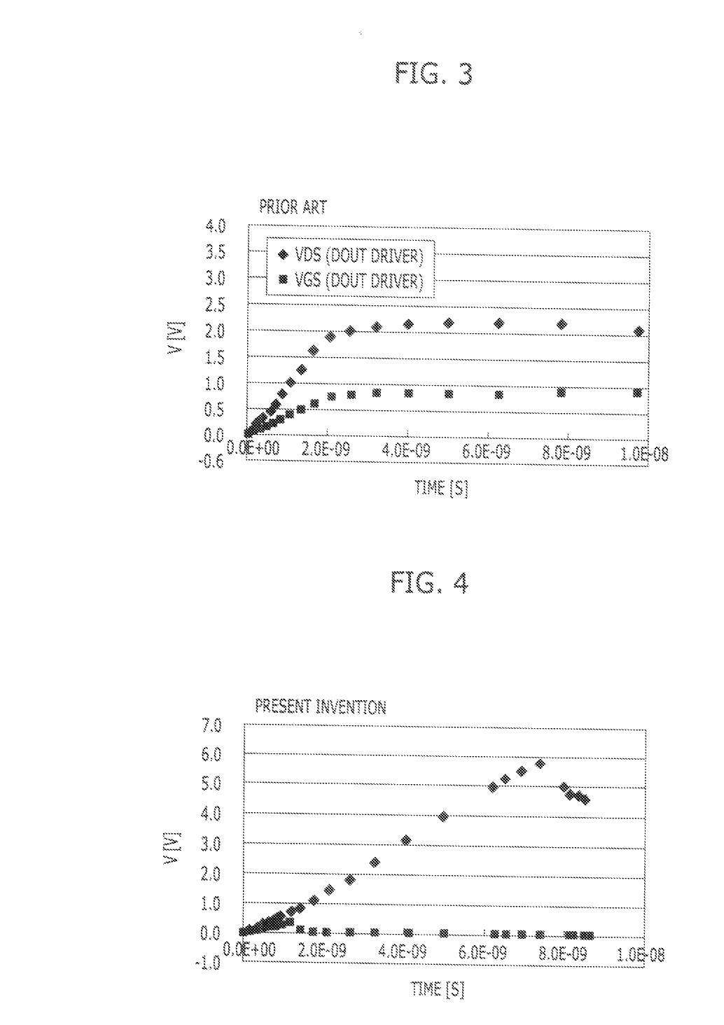

FIG. 3 is a graph showing a simulation result of a conventional data output driver, and FIG. 4 is a graph showing a simulation result of a data output driver in accordance with an embodiment of the present invention.

According to the prior art shown in FIG. 3, it can be seen that a gate-source voltage VGS of the second NMOS transistor N22 is increased up to approximately 1 V while the operation voltage, i.e., a drain-source voltage VDS, is as low as approximately 2.3 V. On the contrary, according to an exemplary embodiment of the present invention as shown in FIG. 4, it can be seen that a gate-source voltage VGS of the second NMOS transistor N22 is increased up to approximately 0.2 V while the operation voltage VDS is increased up to approximately 6 V.

As a result, when static electricity enters the data input/output pad 200, the second NMOS transistor N22 may be prevented from operating (that is, turn on) before the first and second ESD units 201 and 203 operate by making the second NMOS transistor N22 operate as a gate grounded NMOS transistor and thus increasing its operation voltage. In this way, it is possible to prevent the second NMOS transistor N22 and the second resistor R22 from operational failure.

According to an exemplary embodiment of the present invention, a data output driver and a data output resistor can be prevented from operational failure by increasing a threshold voltage so that the data output driver does not operate before an ESD unit operates, when static electricity is input to a data input/output pad.

While the present invention has been described with respect to the specific embodiments, it will be apparent to those skilled in the art that various changes and modifications may be made without departing from the spirit and scope of the invention as defined in the following claims.

What is claimed is:

1. An electrostatic discharge (ESD) protection circuit, comprising:
a detector coupled between a data power source line and a data ground voltage line to detect static electricity and to output a detection voltage on a detection node;
a pre-driver coupled between a power source voltage line and a ground voltage line to output a driving signal on a control node;
a data output driver coupled between a data input/output pad and the data ground voltage line to output data in response to the driving signal; and
a controller coupled between the control node and the data ground voltage line to couple a terminal of the data output driver with the data ground voltage line based on the detection voltage when the static electricity is input.

2. The ESD protection circuit of claim 1, wherein the detector includes:
a capacitor coupled between the data power source line and the detection node; and
a resistor coupled between the detection node and the data ground voltage line.

3. The ESD protection circuit of claim 1, further comprising:
a power clamp coupled in parallel with the detector to be turned on in response to the detection voltage.

4. The ESD protection circuit of claim 3, wherein the power clamp includes:
an NMOS transistor having a drain coupled with the data power source line, a gate coupled with the detection node, and a source and a bulk coupled with the data ground voltage line.

5. The ESD protection circuit of claim 1, wherein the data output driver is a pull-down driver.

6. The ESD protection circuit of claim 1, wherein the data output driver includes:
a resistor having one terminal coupled with the data input/output pad; and
an NMOS transistor including a drain coupled with another terminal of the resistor, a gate coupled with the control node, and a source and a bulk coupled with the data ground voltage line.

7. The ESD protection circuit of claim 1, wherein the pre-driver includes a CMOS inverter between the power source voltage line and the ground voltage line and has an intervening node of a PMOS transistor and an NMOS transistor of the CMOS inverter coupled with the control node to output the driving signal.

8. The ESD protection circuit of claim 1, wherein the controller includes:
an NMOS transistor including a drain coupled with the control node, a gate coupled with the detection node, and a source and a bulk coupled with the data ground voltage line.
